(19) United States
(12) Patent Application Publication
(10) Pub. No.: US 2009/0302995 A1
(43) Pub. Date: Dec. 10, 2009

(54) MULTI DIGITAL DOOR

(76) Inventor: Jang-Ho Park, Daegu (KR)

Correspondence Address: F. CHAU & ASSOCIATES, LLC, 130 WOODBURY ROAD, WOODBURY, NY, 11797, US

(21) Appl. No.: 12/299,383

(22) PCT Filed: May 2, 2007
(86) PCT No.: PCT/KR07/02155

§ 371 Date: Feb. 4, 2009

(30) Foreign Application Priority Data
May 2, 2006 (KR) 10-2006-0039613
May 2, 2006 (KR) 20-2006-0011810

(51) Int. Cl. G05B 23/02

(52) U.S. Cl. 340/3.1

(57) ABSTRACT

The present invention relates to a digital door, and more particularly, to a digital door which is capable of improving security and convenience using network environments, improving safety in an emergency such as a fire, and improving aesthetic and functionality of a door. The digital door includes: a power supply unit that supplies power to the door; an input unit that that mechanically or electromagnetically receives an input signal from a user and converts the received input signal into digital data; a multi-lock unit that has a multi-locking system constituted by a plurality of locks and locks/unlocks the door; a communication unit that connects the door with a network; a memory unit that stores a control program and related data, fire and security-related messages, image and voice data inputted from the input unit; an audio unit that generates an alarm sound according to the messages; and a controller that is connected to the power supply unit, the multi-lock unit, the communication unit, the memory unit and the audio unit for controlling the digital door.

### TECHNICAL FIELD

The present invention relates to a digital door, and more particularly, to a digital door which is capable of improving security and convenience using network environments, improving safety in an emergency such as a fire, and improving aesthetic and functionality of a door.

### BACKGROUND ART

At present, there have been popularized digital door locks equipped with a digital key, a number input key and so on in homes, offices and so on because of convenience of no need of steel key and merit of no risk caused by key loss.

Although security of digital door locks has been more improved with development of digital technologies, there is a limitation in providing a complete security system because of development of various up-to-date technologies to unlock digital door locks.

For example, if digital doors are shocked with electricity, the digital doors are easily unlocked due to abnormality of a digital door lock circuit by the electrical shock. In addition, if a digital door has only one lock, the digital door may be easily unlocked by a tool. Thus, many homes and companies in which digital door locks are installed are exposed to crime.

In this manner, digital locks that have made inroads into analog key markets owing to their convenience and safety have a limitation in providing complete security. Accordingly, there has been proposed a locking system in which an auxiliary lock is added to an existing digital lock. However, this conventional locking system has a problem in that it is insufficient to cope with accidents, such as fires and emergencies, because of different usage.

In addition, with the conventional locking system, since a user can not know trespasser's situation on the spot, there is a high possibility of danger of precautionary accident. Accordingly, many efforts to combine recent information and communication technology including Internet, wireless communication, telematics, etc., with digital locking systems have been made.

### DISCLOSURE OF INVENTION

### Technical Problem

The present invention has been designed to overcome the above and other problems, and it is an object of the invention to provide a digital door which is capable of improving security and convenience using network environments, improving safety in an emergency such as a fire, and improving aesthetic and functionality of a door. Other objects of the present invention will be obvious from the following preferred embodiments.

### Technical Solution

To achieve the above and other objects, according to an aspect of the invention, there is provided a digital door including: a power supply unit that supplies power to the door; an input unit that that mechanically or electromagnetically receives an input signal from a user and converts the received input signal into digital data; a multi-lock unit that has a multi-locking system constituted by a plurality of locks and locks/unlocks the door; a communication unit that connects the door with a network; a memory unit that stores a control program and related data, fire and security-related messages, image and voice data inputted from the input unit; an audio unit that generates an alarm sound according to the messages; and a controller that is connected to the power supply unit, the multi-lock unit, the communication unit, the memory unit and the audio unit for controlling the digital door.

Preferably, the input unit includes an interphone that shows a user an image of a visitor and allows the user to have a conversation with the visitor, and a camera unit for monitor of the visitor and video communication with the visitor.

Preferably, the digital door further includes: a smoke and fire detecting unit that detects smoke and fire, generates an analog signal related to the detected smoke and fire, and converts the generated analog signal into digital data; and an abnormality detecting unit that detects abnormality of the multi-lock unit and the input unit, which may occur due to unauthorized access from the outside.

Preferably, the communication unit includes a communication module to access a wireless network or access a home network interlocking with Internet by being connected to a home terminal apparatus for communication between a mobile terminal and the door.

Preferably, the controller communicates with an external user terminal through the communication unit to perform a notification function and a door opening/closing operation.

Preferably, the digital door further includes a door closer unit that automatically closes an opened door in order to prevent fire and smoke from spreading over.

Preferably, the digital door further includes an anion ventilating unit that ventilates indoor air in a space in which the digital door is installed.

Preferably, the controller controls the multi-lock unit to be opened/closed in multi-step according to a domino fashion that the locks in the multi-lock unit operate sequentially in a preset sequence.

Preferably, the power supply unit, the input unit, the multi-lock unit, the communication unit, the memory unit, the audio unit, the controller, the smoke and fire detecting unit, the abnormality detecting unit, the door closer unit and the anion ventilating unit are formed on one side of the door, the digital door further includes a casing frame that covers and protects the power supply unit, the input unit, the multi-lock unit, the communication unit, the memory unit, the audio unit, the controller, the smoke and fire detecting unit, the abnormality detecting unit, the door closer unit and the anion ventilating unit, and the door is moduled into a body including the components of the door and the casing frame.

### ADVANTAGEOUS EFFECTS

According to the present invention, the digital door can not only strengthen security but also improve user's convenience by performing a multi-step locking and unlocking operation in a domino fashion that the multi-lock unit operates sequentially in a preset sequence. That is, considering that an existing door typically has only one lock, and further includes a separate auxiliary lock due to user's feeling of uneasiness, the multi-lock unit (including two or more locks) is installed to strengthen security, and is locked/unlocked in a domino fashion to improve user's convenience.

In addition, a manual key is installed for each lock of the multi-lock unit in preparation for system abnormality such as power failure or battery power deficiency.

In addition, by installing the anion ventilating unit at the door in order to guide a smooth flow of indoor air, it is possible to remove bad-smell occurring in closed front doors in existing apartments, thereby making uncomfortable environments better.

In addition, by attaching the casing frame to the door, it is possible to not only prevent components of the door from being damaged but also design the door with increased aesthetic feeling, thereby further raising utility and decoration beauty.

In addition, the door includes the smoke and fire detecting unit and so on to perform notification function, portable phone data transmitting/receiving function, office and company attendance management function, gas leak, fire and human body detecting sensor and transfer function, lighting up/down and home appliance ON/OFF function and so on.

### BRIEF DESCRIPTION OF THE DRAWINGS

FIGS. 1 and 2 are views showing a configuration of a security system according to a preferred embodiment of the present invention.

FIG. 3 is a view showing a configuration of a digital door according to a preferred embodiment of the present invention.

FIG. 4 is a view illustrating a multi-step security apparatus using a digital multi-lock unit in a digital door according to a preferred embodiment of the present invention.

FIG. 5 is a view illustrating a multi-step unlocking operation according to a first embodiment of the present invention.

FIG. 6 is a view illustrating a multi-step unlocking operation according to a second embodiment of the present invention.

FIGS. 7 and 8 are a front view and a rear side view showing an external configuration of the digital door, respectively, according to the preferred embodiment of the present invention.

FIG. 9 is a detailed view showing a knob of the digital door according to the preferred embodiment of the present invention.

FIGS. 10 and 11 are views showing a configuration of a multi-lock unit of a digital door according to the preferred embodiment of the present invention.

FIGS. 12 to 15 are views showing a configuration of an opening/closing device of the multi-lock unit of the digital door according to the preferred embodiment of the present invention.

FIGS. 16 and 17 are a front view and a rear side view showing an example of an anion ventilating unit formed in the digital door, respectively, according to the preferred embodiment of the present invention.

FIGS. 18 to 20 are views showing an external configuration of a smoke and fire detecting unit and an absorption door closer unit of the digital door according to the preferred embodiment of the present invention.

FIGS. 21 to 23 are a front view, a rear side view and an exploded view showing an external configuration of a digital door, respectively, according to another preferred embodiment of the present invention.

### MODE FOR CARRYING OUT THE INVENTION

Hereinafter, a digital door and a security system and method using the digital door according to a preferred embodiment of the present invention will be described with reference to the accompanying drawings. In the following embodiments, the same elements are denoted by the same reference numerals, and explanation thereof will be omitted.

### Configuration of Security System

A multi-function digital door 100 according to a preferred embodiment of the present invention can be connected to a wireless network or a wired network in interlocking with Internet by being electrically connected to a home terminal apparatus to organize a security system.

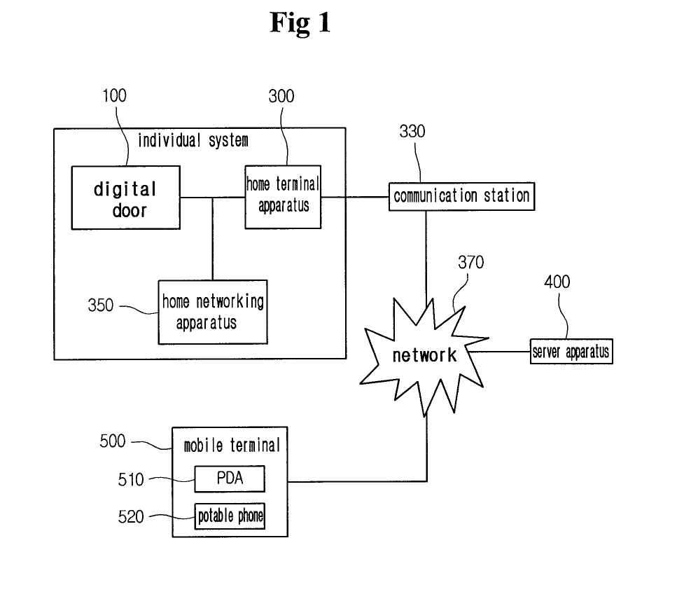

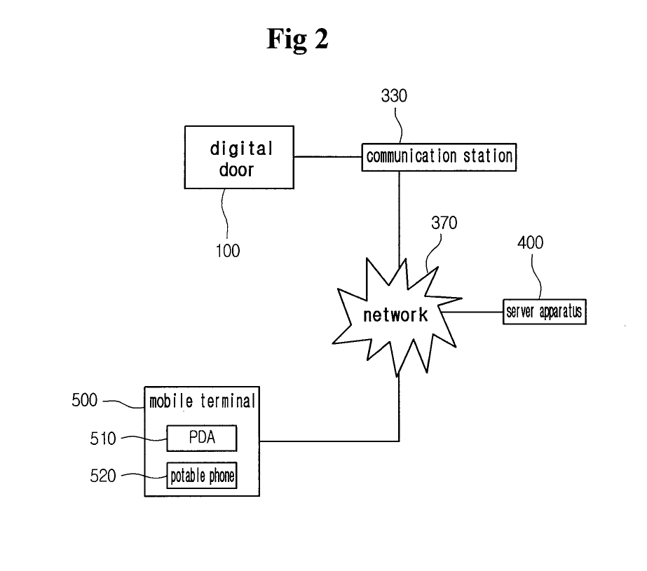

FIGS. 1 and 2 are views showing a configuration of a security system according to a preferred embodiment of the present invention.

Referring to the figures, a multi-step security system according to a preferred embodiment of the present invention includes an individual system including a multi-function digital door 100, a home networking apparatus 350 and a home terminal apparatus 300, and a server apparatus 400 connected to the single system via a communication station 330 and a network 370.

In addition, the individual system can communicate with a mobile terminal 500, such as a PDA 510 and a portable phone 520, via the communication station 330 and the network 370.

The security system according to the preferred embodiment of the present invention can be established as an individual system and a union system. The union system may include a plurality of individual systems and the server 400.

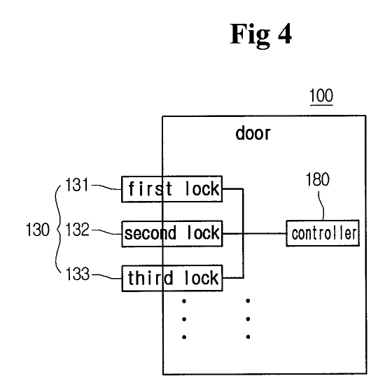

The digital door 100 is constituted by a multi-lock unit 130 (see FIG. 4) including a plurality of locking members. The locking members may be opened/closed (unlocked/locked) in a domino fashion that the locking members operate sequentially in a preset sequence.

The home networking apparatus 350, such as electronic products, a boiler and so on, is connected to a home automation part included in the home terminal apparatus 300.

The home terminal apparatus 300 is a home server connected to the digital door 100 for controlling the digital door 100. In addition, the home terminal apparatus 300 may be connected to the home networking apparatus 350, such as electric lamps, electronic products, a boiler and so on, for performing a home networking function.

In addition, although not shown, the home terminal apparatus 300 may further include telephones, an opening/closing control unit, an interphone, a videophone, a voice communication unit, an image capture setting unit, a voice signal recording unit and so on.

In addition, the home terminal apparatus 300 may not only locally control the above-mentioned components through an input unit but also remotely control the above-mentioned components through the communication station 330 by means of the server apparatus 400 and the mobile terminal 500 at a remote place.

Furthermore, the home terminal apparatus 300 may exchange a variety of state information and security information with the server apparatus 400 and the mobile terminal 500.

The communication station 330 refers to a relay apparatus including a base station for wireless communication and a switcher for wired communication. Here, the wireless and wired communication includes mobile communication such as CDMA, GSM and so on, local area communication such as RFID, NFC and so on, and wired telephone communication such as PSTN (Public Switched Telephone Network). The network 370 includes not only established wired and wireless networks but also networks to be developed in the future.

The server apparatus 400 may be installed in security offices of apartments or buildings, private guard service companies, police stations, police boxes, fire stations and so on. The server apparatus 400 may identify positions of locks using preset identification information or a GPS signal.

The mobile terminal 500 includes personal portable terminals such as portable phones, PDAs and so on.

As an alternative embodiment of the present invention, a multi-step security system may include a multi-function digital door 100, a communication station 330, a network 370, and a mobile terminal 500 such as a PDA 510 and a portable phone 520, as shown in FIG. 2.

Specifically, without a separate home terminal apparatus and a separate home networking apparatus 350, the digital door contains a communication module, such as a CDMA module, which is directly connected to the communication station 330 and the network 370 for communication between the digital door 100 and the mobile terminal 500 including the PDA 510 and the portable phone 520.

In addition, without a separate configuration of the server apparatus 400, the digital door 100 has a notification function to notify family, staffs or a security office of unauthorized access from the outside.

In addition, a key device (not shown) to unlock the multi-function digital door 100 of the present invention may be configured to include a digital key using communication. That is, the digital key can lock and unlock the digital door 100 using not only the mobile terminal 500 that accesses the digital door 100 but also a smart chip employing a local area communication system such as RFID or NFC.

### Basic Configuration of Digital Door

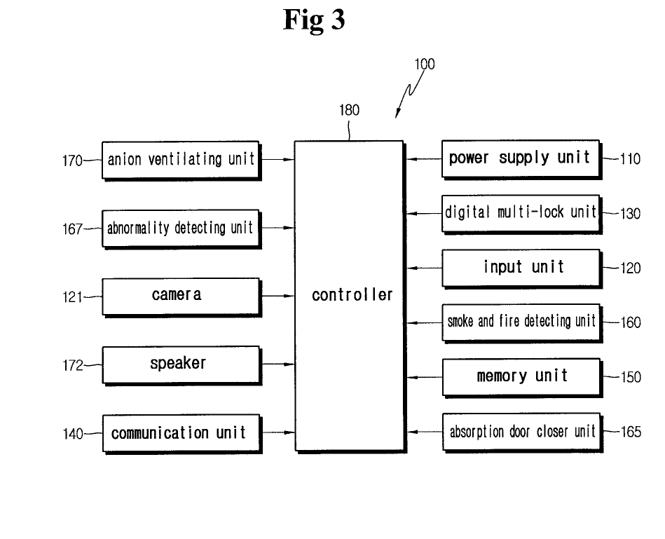

FIG. 3 is a view showing a configuration of the multi-function digital door 100 according to the preferred embodiment of the present invention.

As shown in FIG. 3, the multi-function digital door 100 includes a power supply unit 110 that supplies power to the digital door 100, an input unit 120 that mechanically or electromagnetically receives an input signal from a user and converts the received input signal into digital data, a digital multi-lock unit 130 that locks and unlocks the digital door 100 according to the input signal from the user through the input unit 120, and a communication unit 140 that connects the digital door 100 with a network.

The input unit 120 may be provided with an interphone that shows the user an image of a visitor and allows the user to have a conversation with the visitor.

In addition, the multi-function digital door 100 may further include a camera 121 for monitor of a visitor and video communication with the visitor.

The digital multi-lock unit 130, which is a multiplex and/or multi-step security system, basically has a plurality of locks, such as auxiliary locks, contained in the digital door 100, thereby strengthening security with a multi-locking system.

The communication unit 140 contains a communication module, such as a CDMA module or a GSM module, which accesses a wireless network or accesses a home network interlocking with Internet by being connected to a home terminal apparatus for communication between a mobile terminal (not shown) and the digital door 100. The mobile terminal may include personal portable terminals such as portable phones, PDAs and so on.

In addition, the digital door 100 further includes a memory unit 150 that stores a control program and related data, fire and security-related messages, image and voice data inputted from the input unit 120, etc.

In addition, the digital door 100 further includes a smoke and fire detecting unit 160 that detects smoke and fire, generates an analog signal related to the detected smoke and fire, and converts the generated analog signal into digital data, and an abnormality detecting unit 167 that detects abnormality of the digital multi-lock unit 130 and the input unit 120, which may occur due to unauthorized access from the outside.

Specifically, the smoke, fire and abnormality are detected by sensors which may include a motion detecting sensor, an impact detecting sensor, a heat detecting sensor, a fire detecting sensor, a gas detecting sensor, etc.

In addition, the digital door 100 further includes an absorption door closer unit 165 that automatically closes an opened door in order to prevent fire and smoke from spreading over, an anion ventilating unit 170 that ventilates internal air in a front door or the like at which the digital door is installed, a display unit (not shown) that displays messages related to the fire and security, and a speaker 172 that generates an alarm sound about fire or unauthorized access from the outside.

In addition, the digital door 100 may further include a controller 180 that controls the power supply unit 110, the input unit 120, the digital multi-lock unit 130, the communication unit 140, the memory unit 150, the smoke and fire detecting unit 160, the absorption door closer unit 165, the abnormality detecting unit 167, the anion ventilating unit 170 and the speaker 172, which are connected to the controller 180.

The controller 180 performs a notification function to notify family, staffs or a security office of the unauthorized access from the outside through the communication unit 140.

In addition, the controller 180 may control the multi-lock unit 130 to be opened/closed (unlocked/locked) in a domino fashion that the locks in the multi-lock unit 130 operate sequentially in a preset sequence.

With the configuration as described above, the multi-function digital door can perform notification function, portable phone data transmitting/receiving function, office and company attendance management function, gas leak, fire and human body detecting sensor and transfer function, lighting up/down and home appliance ON/OFF function and so on.

FIG. 4 is a view illustrating a multi-step security apparatus using the digital multi-lock unit 130 in the digital door 100 according to the preferred embodiment of the present invention.

The digital door 100 according to the preferred embodiment of the present invention is constituted by the multi-lock unit including a plurality of locks and performs a multi-step locking operation that the locks operate sequentially in a preset sequence.

Referring to FIG. 4, the digital multi-lock unit 130 includes a plurality of locks 131, 132 and 133 and a controller 180 for controlling the locks. The controller 180 may be electrically connected to the home terminal apparatus 300 or a wired/wireless network via the communication unit 140.

As described above, the digital door 100 can perform the multi-step locking operation in a domino fashion that the locks operate sequentially in a preset sequence.

In addition, a key device (not shown) to unlock the multi-function digital door of the present invention may be configured to include a digital key using communication. That is, the digital key can lock and unlock the multi-lock unit 130 using not only a wireless telephone such as the mobile terminal that accesses the communication unit of the digital door 100 under control of the controller 180 but also a smart chip employing a local area communication system such as RFID or NFC.

In addition, the digital door may be locked and unlocked not only by inputting a password through the input unit but also by using an analog key manually.

### Multi-Step Operation Method

The digital door 100 of the present invention is constituted by a multi-lock unit including a plurality of locks, and the multi-lock unit may be opened in a domino fashion that the locks operate sequentially in a preset sequence through the controller. The multi-lock unit may be also closed either in the same domino fashion or at once.

According to the present invention, key information corresponding to the plurality of locks may be transmitted either sequentially or simultaneously. According to a first embodiment of the present invention, a multi-step unlocking method includes the steps of: (a) receiving a multi-step authentication request from a key; (b) requesting the key to provide an encryption key; (c) receiving the encryption key from the key; (d) authenticating the encryption key and unlocking a lock corresponding to the encryption key; and (e) repeating the steps (c) and (d) by preset number of times in correspondence to the number of locks. According to a second embodiment of the present invention, a multi-step unlocking method includes the steps of: (a) receiving a multi-step authentication request from a key; (b) requesting the key to provide an encryption key; (c) receiving a plurality of encryption keys corresponding to the number of locks from the key; and (d) performing an authentication operation for the encryption keys and a unlocking operation for the locks corresponding to the encryption keys by preset number of times in correspondence to the number of encryption keys.

In the following description, a case where the unlocking operation is performed using a smart chip will be described, however, it is to be understood the digital door may be locked/unlocked manually, or through preset remote telephone communication or local/contact communication, or through a key input unit.

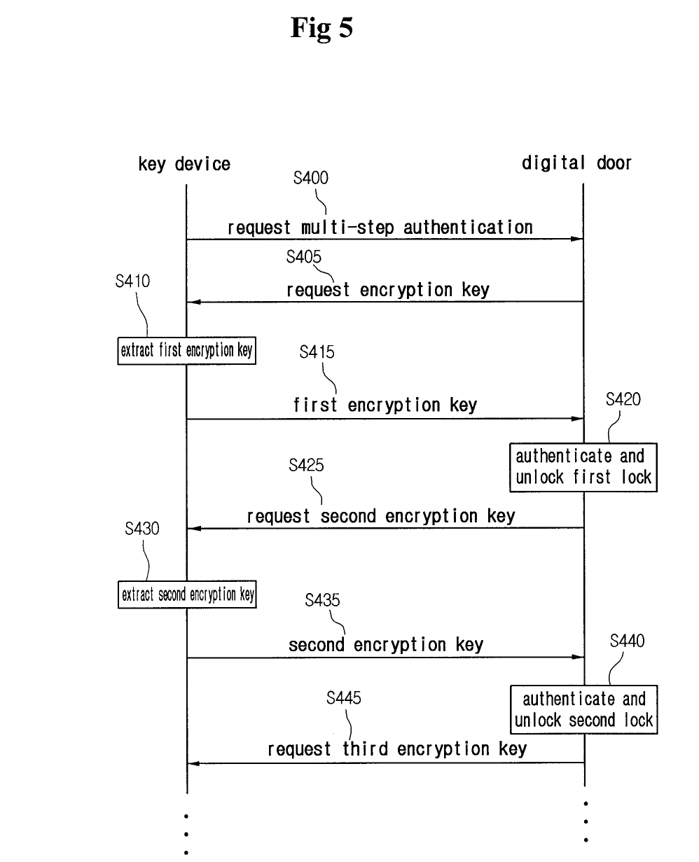

FIG. 5 is a view illustrating a multi-step unlocking operation according to a first embodiment of the present invention.

Referring to FIG. 5, if a multi-step authentication request is made from a key device to the digital door (Step S400), the digital door receives this authentication request and requests the key device to provide an encryption key (Step S405). According to the first embodiment, the key device extracts a first encryption key (Step S410) and transmits the extracted first encryption key to the digital door (Step S415). Then, the digital door authenticates the first encryption key and unlocks a first lock (Step S420). Next, the digital door requests the key device to provide a second encryption key (Step S425).

Then, the key device extracts the second key encryption key (Step S430) and transmits the extracted second encryption key to the digital door (Step S435). Then, the digital door authenticates the second encryption key and unlocks a second lock (Step S440). Next, the digital door requests the key device to provide a third encryption key (Step S445). After the above process is performed for a plurality of locks, the unlocking operation is completed for the digital door.

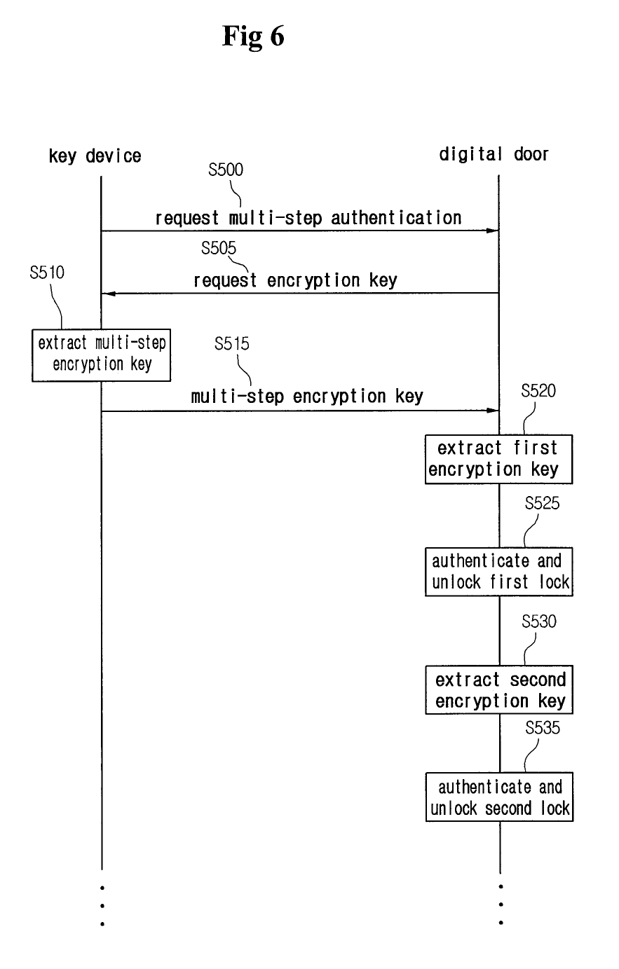

FIG. 6 is a view illustrating a multi-step unlocking operation according to a second embodiment of the present invention.

In the unlocking operation shown in FIG. 6, a plurality pf encryption keys corresponding to a plurality of locks has a series of data structure to be transmitted at once, and the digital door extracts and authenticates the encryption keys corresponding to the locks and unlocks the locks. Here, the plurality of encryption keys may be extracted and authenticated in a domino fashion in a preset sequence. When the first encryption key is normally authenticated (that is, when the first encryption key is extracted) (Step S520), the second and third encryption keys are authenticated in a domino fashion so that the locks can be unlocked in turn (Steps S525, S530 and S535).

However, if the first encryption key operates physically/forcedly or abnormally, the controller transmits a message, which indicates an unauthorized access from the outside, to a mobile terminal of a user in the form of a SMS (Short Message service). Simultaneously, the controller stops the operation of the key device automatically or the user instructs the second and third locks not to be unlocked so that the digital door can remain in a locked state.

In addition, the above unlocking method allows the locks to be unlocked only by means of a normal manual key or through reasonable authentication.

Other operations are similar to those in the first embodiment, and therefore, explanation thereof will be omitted.

### Detailed Configuration of Digital Door

Hereinafter, the configuration of the multi-function digital door of the present invention will be described in more detail.

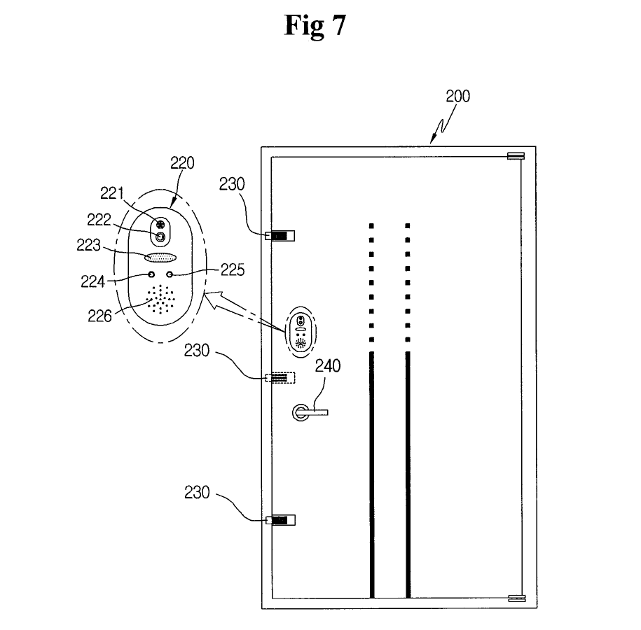

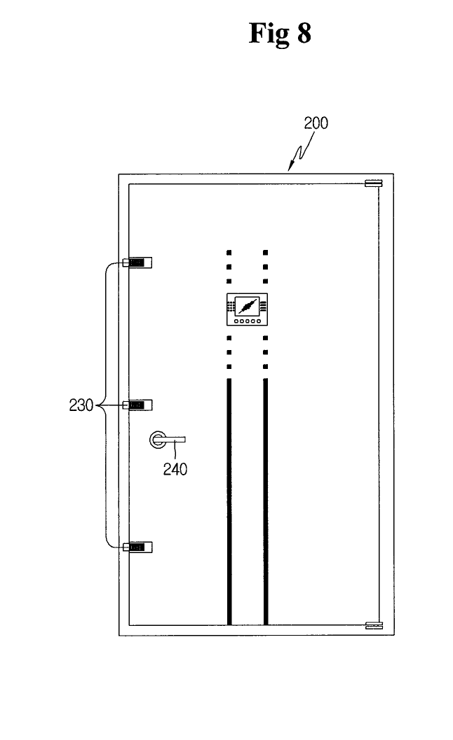

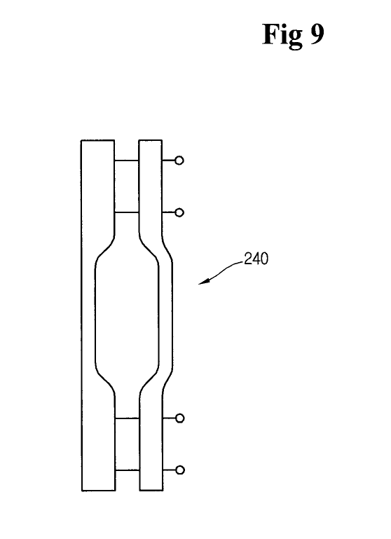

FIGS. 7 and 8 are a front view and a rear side view showing an external configuration of the multi-function digital door 100, respectively, according to the preferred embodiment of the present invention, and FIG. 9 is a detailed view showing a knob of the multi-function digital door 100 according to the preferred embodiment of the present invention.

As shown in FIGS. 7 and 8, an input unit 220 through a user can input a signal for opening/closing the door is provided at one side of the multi-function digital door 200 of the present invention.

In this embodiment, the input unit 220 may include a microphone 221, a camera 222, a smart card receiving antenna 223, a doorbell 224, a call button (reset) 225, a speaker 226 and so on which are integrally formed. A user can monitor a visitor and have a video/voice conversation with the visitor through the camera 222, the microphone 221 and the speaker 226, and call with a telephone number (landlord's telephone number, number 119 for fire/accident, etc.) set through the call button 225. This makes it possible to call with landlord through a CDMA module contained in a communication unit (not shown) of the digital door 200 so as to unlock the digital door 200 or make an urgent telephone in a state of emergency.

In addition, the input unit 220 may be embodied by a contact or non-contact card through the smart card receiving antenna 223 or a keypad-typed digital key to unlock the digital door 200 through number input.

As shown in FIG. 9, a knob 240 of the digital door 200 of the present invention has a sensor therein to realize a Fenwick function to automatically open the digital door 200 by one-touch or when a user catches the knob. Particularly, even a multi-lock can be opened by one-touch or when the user catches the knob, which is advantage for shelter against fire or emergency.

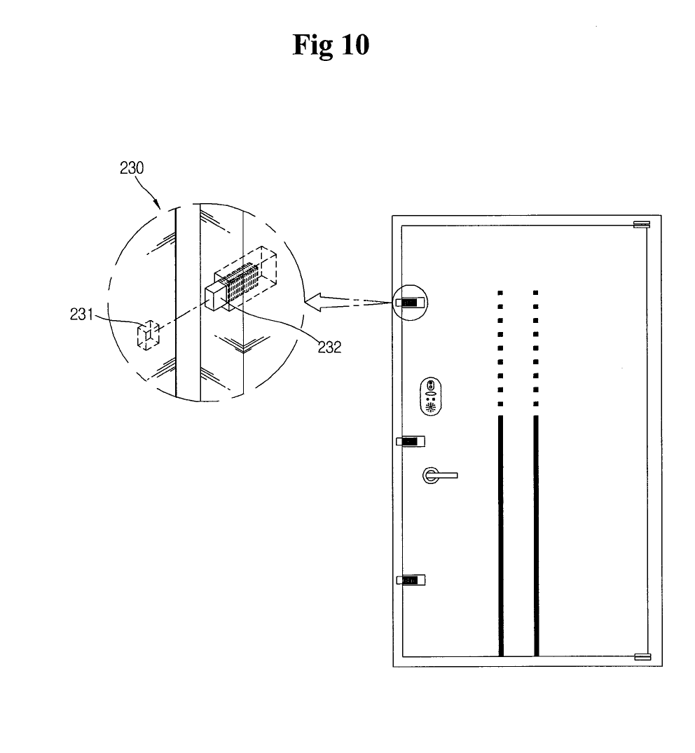

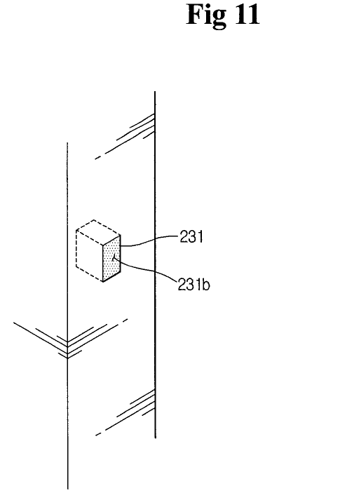

FIGS. 10 and 11 are views showing a configuration of a multi-lock unit 230 of the digital door 200 according to the preferred embodiment of the present invention.

As shown in FIGS. 10 and 11, the multi-lock unit 230 of the digital door 200 has a plurality of locking holes 231 formed on a side of a wall to which the door is attached, and a plurality of locks 232 combined to the locking holes 231. The digital door 200 is locked and unlocked in a multi-locking system using the plurality of locks 232.

The opening/closing (unlocking/locking) operation of the plurality of locks 232 is performed in multi-step according to the domino fashion that the locks operates sequentially in the preset sequence, as shown in FIGS. 4 and 5.

In addition, internal sides of the locking holes 231 are surrounded by a silicon rubber packing 231b to cover the locking holes 231 just as a curtain when the locks 232 are opened.

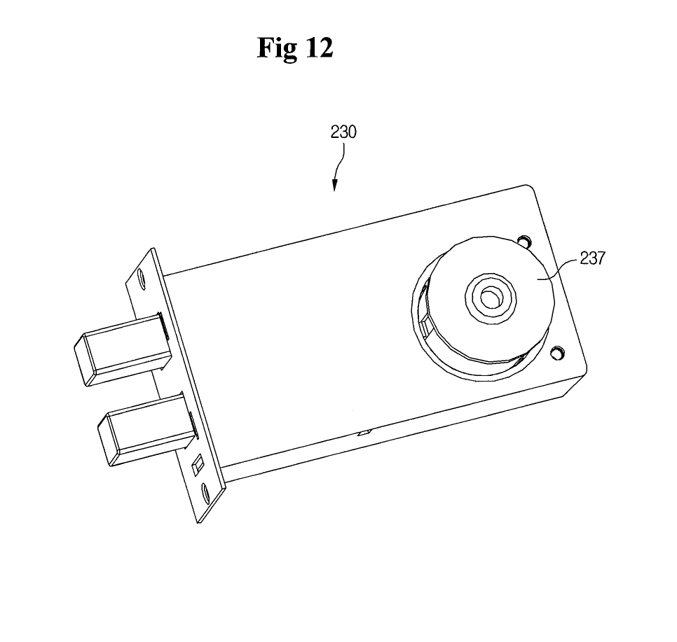

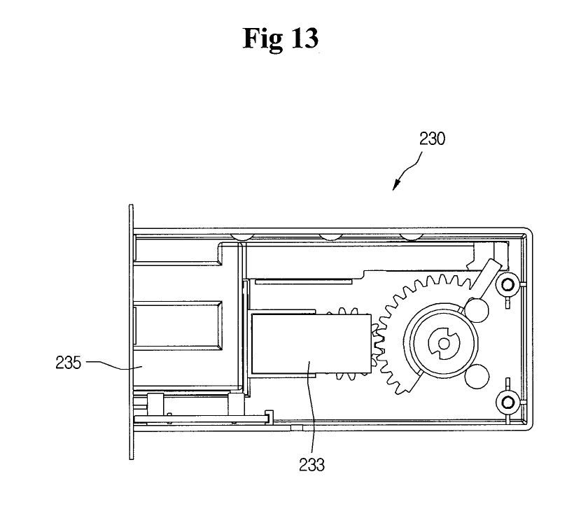

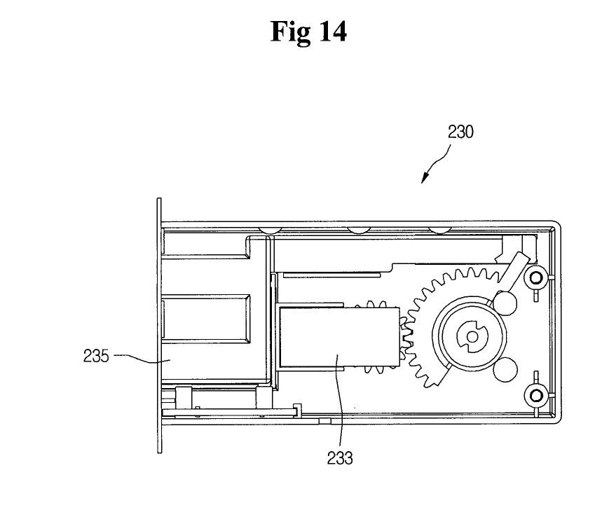

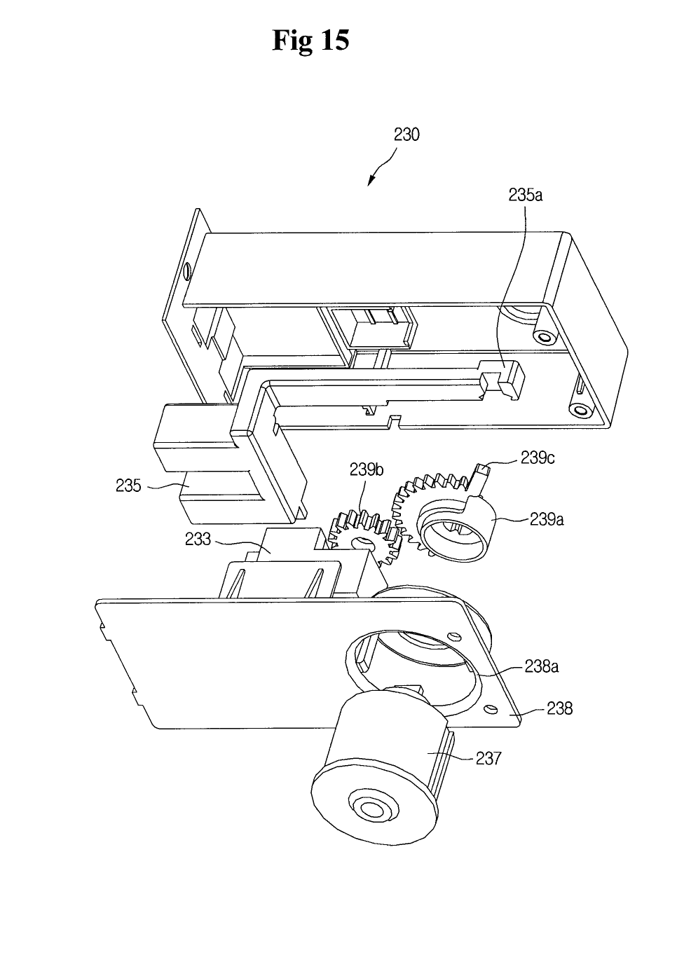

FIGS. 12 to 15 are views showing a configuration of an opening/closing device of the multi-lock unit 230 of the digital door 200 according to the preferred embodiment of the present invention.

As shown in the figures, open/close of the multi-lock unit 230 may be implemented with an electronic motor gear dead ball type.

That is, when the door is opened/closed by a motor 233, the motor 233 advances a dead ball 235 to a locking hole (not shown) when the door is closed, and reverses the dead ball 235 from the locking hole (not shown) when the door is opened.

While the motor 233 advances/reverses the dead ball 235 to/from the locking hole (not shown) according to an instruction of the controller at normal times, the door can be opened/closed manually by means of a plurality of keys 237 provided for the plurality of locks of the multi-lock unit 230 in an emergency or if necessary.

That is, for the manual opening/closing, the door can be opened/closed by rotating the key 237 along a key hole 238a formed in a cover 238 of the multi-lock unit 230. For example, if the door is to be opened, when the key 237 is counterclockwise rotated, a first gear 239a engaging with the key 237 engages with a second gear 239b of the motor 233 in interlocking with the first gear 239a, thereby advancing a latch 235 connected to the motor 233 to the locking hole (not shown).

On the other hand, if the door is to be closed, when the key 237 is clockwise rotated, the first gear 239a engaging with the key 237 engages with the second gear 239b of the motor 233 in interlocking with the first gear 239a, thereby reversing the latch 235 connected to the motor 233 from the locking hole (not shown).

The open/close of the door is independent of whether the key is rotated clockwise or counterclockwise to close the door, and the combination of the first gear 239a and the second gear 239b may be implemented by combination of rack and pinion

In addition, the door may be opened/closed by advancing/reversing the dead ball when the second gear 239b is formed on one side of the motor 233, a projection 239c is formed on one side of the first gear 239a and engages with a groove 235a of the dead ball, and the first gear 239a rotates as the second gear 239b rotates.

In this manner, the digital door 200 can be opened/closed using not only the password input/smart card through the input device but also the key 237 manually. When the digital door 200 is manually opened/closed using the key 237, it is preferable to make the key hole 238a not exposed or indirectly exposed to the outside by using a rubber packing sensor finishing device such that an unauthorized person can not know position of the locks.

In addition, the type of the manual key and a key system may be installed in the multi-lock unit in various different forms so that unauthorized persons can not open the door.

In addition, the type of the manual key and the key system can be utilized against system abnormality such as power failure or battery power deficiency.

In addition, in a case where a door user is changed, if only the manual key is replaced with a new one, a next user can use the door in safety without feeling of uneasiness of replica of the old key by the previous user.

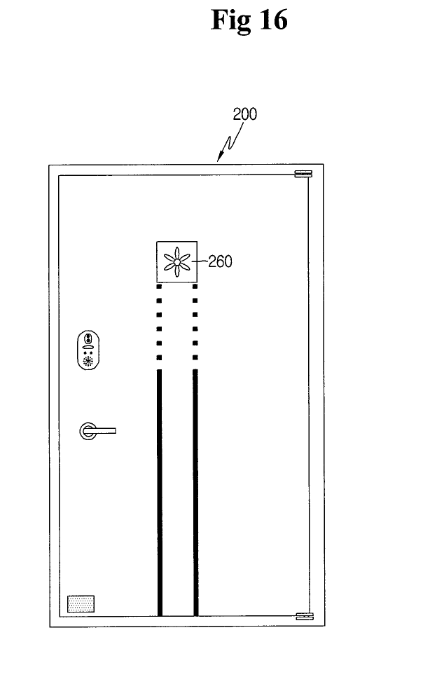

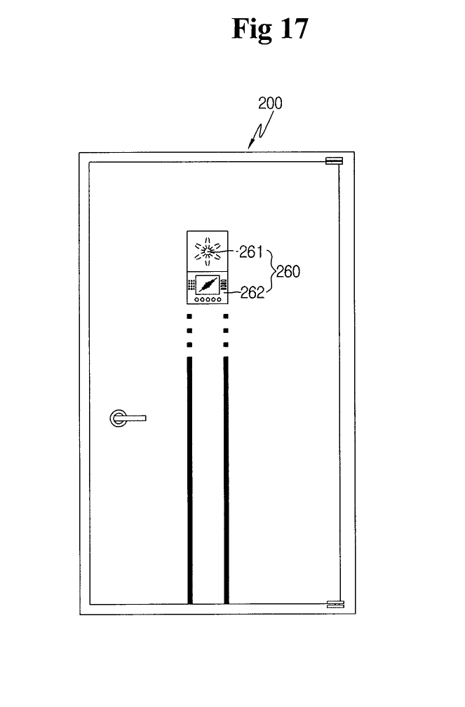

FIGS. 16 and 17 are a front view and a rear side view showing an example of an anion ventilating unit 260 formed in the digital door 200, respectively, according to the preferred embodiment of the present invention.

As shown in FIGS. 16 and 17, the anion ventilating unit 260 includes a ventilating fan 261 that exhausts indoor air to the outside and introduces outdoor air into the inside, and a ventilating fan controller 262 that controls the ventilating fan 261.

The ventilating fan controller 262 detects in real time through a sensor (not shown) whether or not indoor air in the front door is clean, controls a driving timing of the ventilating fan 261 based on a result of the detection, and generates antifungal and/or negative ions to clean the indoor air. The ventilating fan controller 262 may be integrated into the controller of the digital door 200.

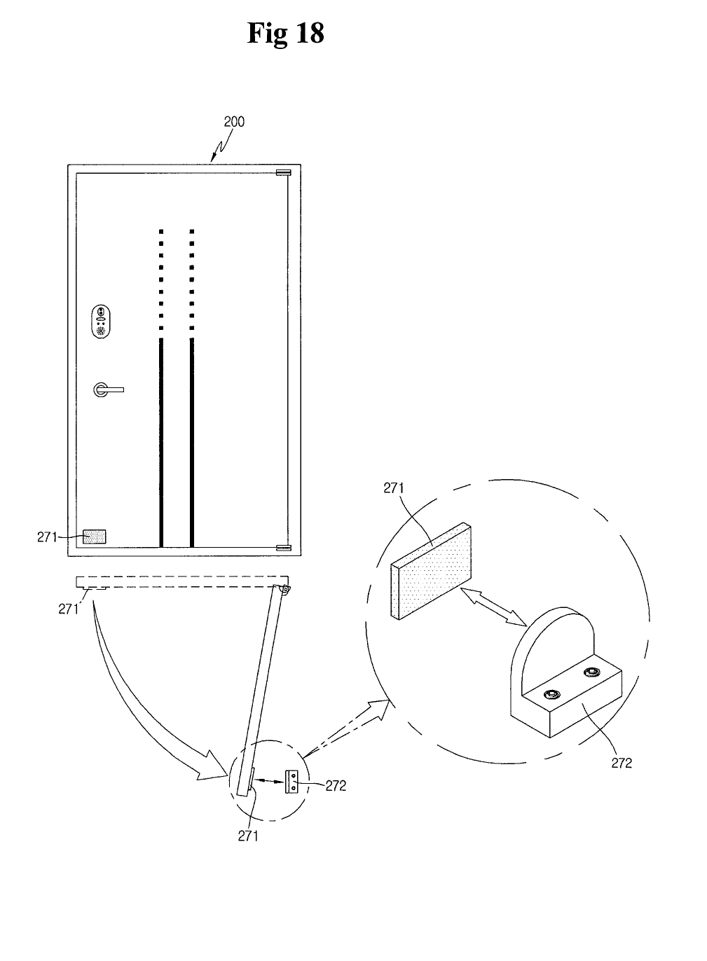

FIGS. 18 to 20 are views showing an external configuration of a smoke and fire detecting unit and an absorption door closer unit of the digital door 200 according to the preferred embodiment of the present invention.

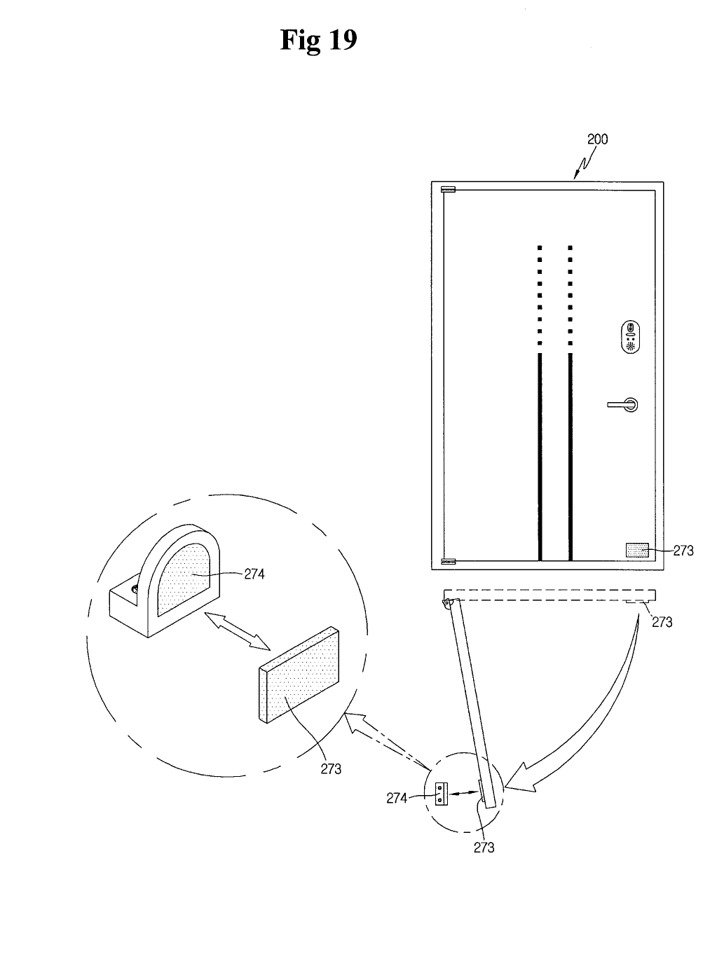

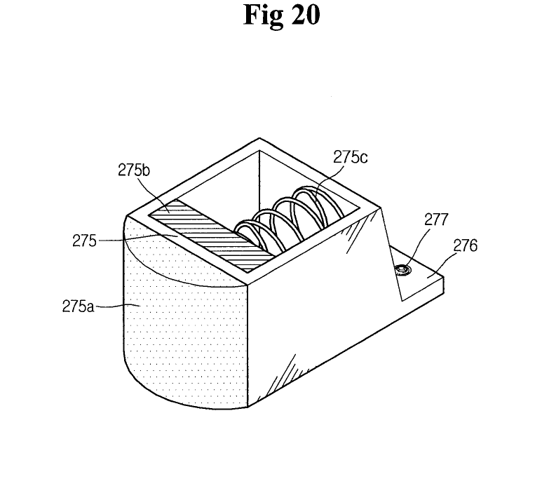

FIG. 18 shows the smoke and fire detecting unit of a right side-opened and automatic-closed type, FIG. 19 shows the smoke and fire detecting unit of a left side-opened and automatic-closed type, and FIG. 20 shows details of the absorption door closer unit.

As shown in FIGS. 18 and 19, smoke and fire detecting sensors 271 and 273 to detect smoke and fire are provided at a lower side of the digital door 200.

In addition, absorption door closer units 272 and 274 are provided at positions at which the digital door 200 draws a 90° semi-circle clockwise (left side-opened) or counterclockwise (right side-opened). At this time, the smoke and fire detecting sensors 271 and 273 of an electromagnet type are electromagnetically coupled with the absorption door closer units 272 and 274 which are neodymium magnets. That is, the smoke and fire detecting sensors 271 and 273 of the door are adhered to the absorption door closer units 272 and 274 by an attractive force at ordinary times such that the smoke and fire detecting sensors 271 and 273 are fixed at positions at which the absorption door closer units 272 and 274 are formed, while, at fire, the smoke and fire detecting sensors 271 and 273 are supplied with power and secedes from the absorption door closer units 272 and 274 by a repulsive force, thereby closing the door automatically. This gives a pedestrian a convenience of passage by fixing the door at a predetermined position at ordinary times and prevents smoke and fire from spreading over by closing the door automatically at fire.

In addition, the absorption door closer units 272 and 274 may be installed at positions at which the digital door 200 draws 60°, 90° and 120° semi-circles clockwise (left side-opened) or counterclockwise (right side-opened). This makes it possible to fix the open position of the door at a proper angle, thereby giving a user a convenience.

As shown in FIG. 20, the absorption door closer units 272 and 274 includes a neodymium magnet unit 285 electromagnetically coupled with the smoke and fire detecting sensor (not shown) formed at the lower side of the door, and a holder 276 that supports the neodymium magnet unit 275 and fixes it on a floor at a predetermined angle.

In addition, the neodymium magnet unit 275 includes a front rubber packing 275a having a cushion to absorb impact when the neodymium magnet 275 is combined to the door, a neodymium magnet 275b electromagnetically coupled with the smoke and fire detecting sensor, and a spring 275c as a buffer that supports the neodymium magnet 275b and absorbs impact at collision with the door.

In addition, a fixing piece 277 is combined to a fixing hole formed in the holder 276 supporting the neodymium magnet unit 275 so that the neodymium magnet unit 275 can be fixed on a floor at a predetermined angle.

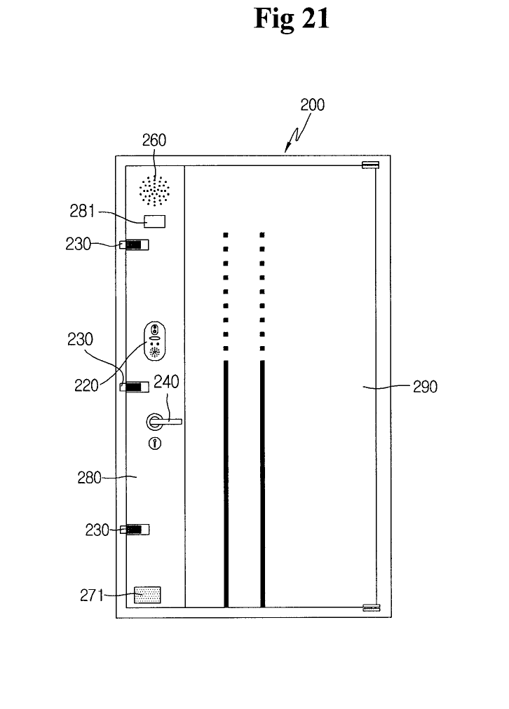

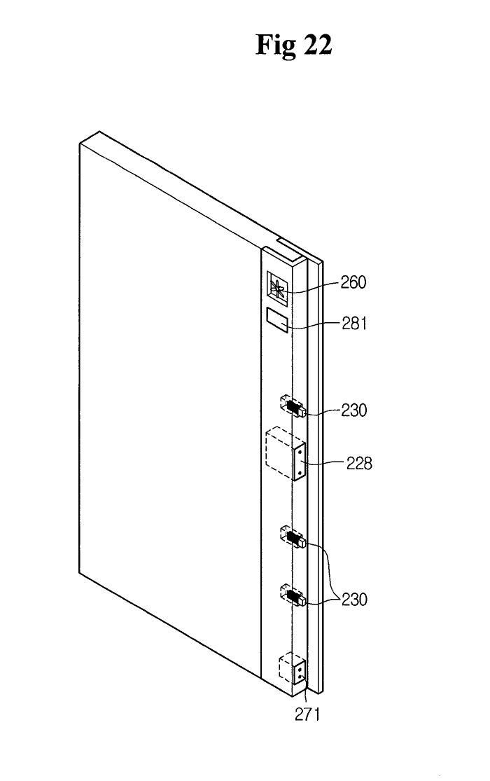

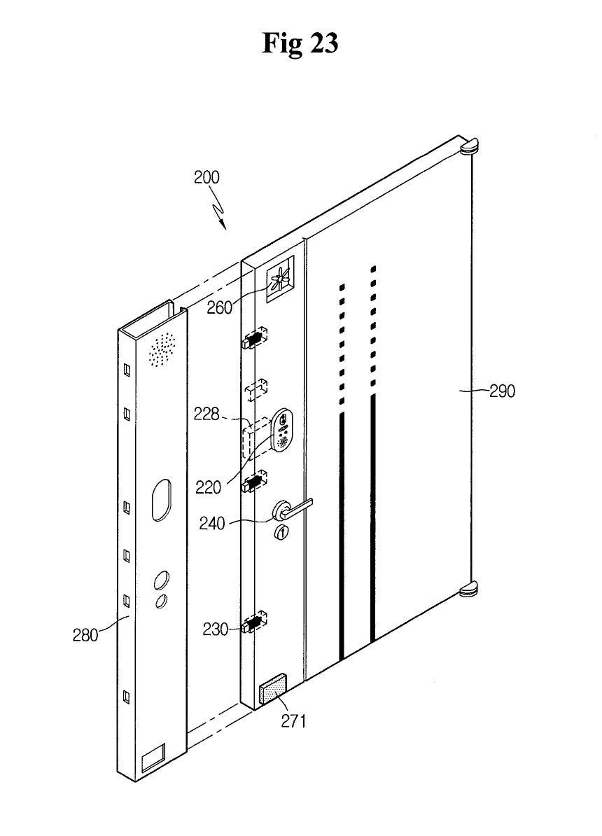

FIGS. 21 to 23 are a front view, a rear side view and an exploded view showing an external configuration of the multi-function digital door 200, respectively, according to another preferred embodiment of the present invention.

As shown in FIGS. 21 to 23, the multi-function digital door 200 of the present invention includes a door body 290 and a casing frame 280 that is combined to one side (inside or outside) of the door body 290 in order to protect the door body 290.

Specifically, the casing frame 280 is installed at portions of the door, which are likely to be damaged (for example, the knob 240 for opening/closing the door, the input unit 220 including a microphone, a speaker, a smart card receiving antenna, etc., in order to prevent the door body 290 from being damaged.

Here, the input unit 220 may correspond to a keypad for number input, a camera, a doorbell, a microphone, an RF card reader, a fingerprint recognizer, etc.

In addition, as shown in FIGS. 21 to 23, the anion ventilating unit 260 and an emergency exit automatic guide lamp 281 that indicates a door direction at an emergency such as fie may be installed at one side, for example a lateral upper side, of the door body 290, and the smoke and fire detecting sensors 271 may be installed at a lower side of the door body 290.

In addition, at one side of the door body 290 are installed the digital multi-lock unit 230 constituted by the plurality of locks for multi-step/multiplex locking and a controller 228 that is electrically connected to the input unit 220, the digital multi-lock unit 230, the anion ventilating unit 260, the guide lamp 281 and the smoke and fire detecting sensor 271 for controlling operation of these components. The controller 228 may include a PCB board on which a central processing unit, memories and so on are mounted, and a power supply that supplies power to the PCB board.

In this manner, all the components for implementing the multi-function of the door and the casing frame 290 are formed in one side of the door body 290. In this case, the casing frame 280 can prevent the components of the door from being damaged due to external impact or being broken by trespassers.

In addition, all the components of the door that implement the multi-function of the digital door of the present invention may be moduled through the casing frame 280. That is, the components that implement the multi-function of the door and the casing frame 280 covering the components may be installed on one side of the door body 290, or the casing frame 280 is combined to one side of the door body 290 and the components that implement the multi-function of the door may be installed on the casing frame.

In this manner, the casing frame may be configured to be combined to the door by forming the casing frame as a cover to protect the door body, or by forming the casing frame as a component independent of the door and forming the components of the door on the casing frame. Such modulation of the casing frame makes it possible to improve functionality and productivity of doors by separate manufacture of the door body 290 and the casing frame 280.

In addition, it is possible to simply exchange a battery and check all the components of the door in the casing frame.

In addition, since the casing frame 280 covers portions of the door which are likely to be damaged, the door can be designed with improved aesthetic feeling.

In addition, one of aluminum, iron (steel), stainless steel and wood may be used as material of the casing frame 280, which may be assembled in the form of extruding, cutting, bending and pressing.

### INDUSTRIAL APPLICABILITY

According to the present invention, the digital door is capable of communicating with servers and terminals at a remote place to strengthen security of the door, which allows further approach to ubiquitous environments.

While the invention has been shown and described with reference to preferred embodiments, it will be understood by those skilled in the art that various changes in form and details may be made without departing from the spirit and scope of the appended claims.

1. A digital door comprising:
a power supply unit that supplies power to the door;
an input unit that that mechanically or electromagnetically receives an input signal from a user and converts the received input signal into digital data;
a multi-lock unit that has a multi-locking system constituted by a plurality of locks and locks/unlocks the door;
a communication unit that connects the door with a network;
a memory unit that stores a control program and related data, fire and security-related messages, image and voice data inputted from the input unit;
an audio unit that generates an alarm sound according to the messages; and
a controller that is connected to the power supply unit, the multi-lock unit, the communication unit, the memory unit and the audio unit for controlling the digital door.

2. The digital door of claim 1, wherein the input unit includes an interphone that shows a user an image of a visitor and allows the user to have a conversation with the visitor, and a camera unit for monitor of the visitor and video communication with the visitor.

3. The digital door of claim 1, further comprising:
a smoke and fire detecting unit that detects smoke and fire, generates an analog signal related to the detected smoke and fire, and converts the generated analog signal into digital data; and
an abnormality detecting unit that detects abnormality of the multi-lock unit and the input unit, which may occur due to unauthorized access from the outside.

4. The digital door of claim 1, wherein the communication unit includes a communication module to access a wireless network or access a home network interlocking with Internet by being connected to a home terminal apparatus for communication between a mobile terminal and the door.

5. The digital door of claim 4, wherein the controller communicates with an external user terminal through the communication unit to perform a notification function and a door opening/closing operation.

6. The digital door of claim 1, further comprising a door closer unit that automatically closes an opened door in order to prevent fire and smoke from spreading over.

7. The digital door of claim 1, further comprising an anion ventilating unit that ventilates indoor air in a space in which the digital door is installed.

8. The digital door of claim 1, wherein the controller controls the multi-lock unit to be opened/closed in multi-step according to a domino fashion that the locks in the multi-lock unit operate sequentially in a preset sequence.

9. The digital door of claim 8, wherein the power supply unit, the input unit, the multi-lock unit, the communication unit, the memory unit, the audio unit, the controller, the smoke and fire detecting unit, the abnormality detecting unit, the door closer unit and the anion ventilating unit are formed on one side of the door, the digital door further comprising a casing frame that covers and protects the power supply unit, the input unit, the multi-lock unit, the communication unit, the memory unit, the audio unit, the controller, the smoke and fire detecting unit, the abnormality detecting unit, the door closer unit and the anion ventilating unit, wherein the door is moduled into a body including the components of the door and the casing frame.

10. A digital door comprising:
a multi-lock unit that has a multi-locking system constituted by a plurality of locks and locks/unlocks the door; and
a controller that controls the multi-lock unit,
wherein a key is installed at each of covers of the plurality of locks and the door is opened/closed by rotating the key.

11. The digital door of claim 10, further comprising:
a first gear that engages with the key; and
a second gear that is formed at one side of a motor to drive the locks,
wherein the door is opened/closed by moving the locks connected to the motor as the first gear engages with the second gear in interlocking therebetween when the key is rotated.

12. The digital door of claim 11, wherein a projection that engages with a groove of the locks is formed at one side of the first gear, and the door is opened/closed by moving a dead ball while the first gear is rotated in interlocking with the second gear as the second gear is rotated.

13. The digital door of claim 10, wherein the controller controls the multi-lock unit to be opened/closed in multi-step according to a domino fashion that the locks in the multi-lock unit operate sequentially in a preset sequence.

14-15. (canceled)

16. A digital door comprising:
a smoke and fire detecting unit that is formed at one side of the door, detects smoke and fire, generates an analog signal related to the detected smoke and fire, and converts the generated analog signal into digital data; and
a door closer unit that is electromagnetically coupled with the smoke and fire detecting unit, is installed at a predetermined position at which the door is moved, and fixes the door,
wherein, according to user's intention, the smoke and fire detecting unit is adhered to the door closer unit by an attractive force at ordinary times such that the smoke and fire detecting unit is fixed at the predetermined position, while, at smoke and fire, the smoke and fire detecting unit is supplied with power and the door closer unit secedes from the predetermined position by a repulsive force between the smoke and fire detecting unit and the door closer unit, so that the door is automatically closed.

17. The digital door of claim 16, wherein the door closer unit includes a neodymium magnet unit that is electromagnetically coupled with the smoke and fire detecting unit, and a holder that supports the neodymium magnet unit and fixes the neodymium magnet unit at the predetermined position.

18. The digital door of claim 17, wherein the neodymium magnet unit includes a front rubber packing having a cushion to absorb impact when the neodymium magnet is combined to the door, a neodymium magnet that is electromagnetically coupled with the smoke and fire detecting unit, and a spring as a buffer that supports the neodymium magnet and absorbs impact at collision with the door.

19-21. (canceled)
